(19) United States
(12) Patent Application Publication
(10) Pub. No.: US 2014/0342465 A1
(43) Pub. Date: Nov. 20, 2014

(54) LABORATORY AUTOMATED SYSTEM WITH COMMON SAMPLE BUFFER MODULE

(71) Applicant: Roche Diagnostics Operations, Inc., Indianapolis, IN (US)

(72) Inventors: Joerg Haechler, Oberwil b. Zug (CH); Florian Schindler, Sattel (CH); Georgios Spitadakis, Cham (CH)

(73) Assignee: Roche Diagnostics Operations, Inc., Indianapolis, IN (US)

(21) Appl. No.: 14/271,550

(22) Filed: May 7, 2014

(30) Foreign Application Priority Data
May 15, 2013 (EP) 13167874.0

(51) Int. Cl. G01N 1/28

(52) U.S. Cl. CPC G01N 1/28
USPC 436/174; 422/65

(57) ABSTRACT

A new laboratory automated system comprising a plurality of work cells coupled to a conveyor and a method for processing sample tubes are disclosed, both of which enable a system to maintain the maximum overall throughput regardless of the number and throughput of the individual work cells and regardless of the frequency at which sample tubes are loaded into the system. This is achieved by a sample buffer module coupled to the conveyor, the sample buffer module being in common to the plurality of work cells, and by a sample workflow manager configured to dispatch sample tubes from the sample buffer module to the work cells via the conveyor with a frequency for each work cell, which is equal to the sample processing throughput of each respective work cell.

### CROSS-REFERENCE TO RELATED APPLICATIONS

This application claims priority to EP 13167874.0, filed May 15, 2013, which is hereby incorporated by reference.

### BACKGROUND

The present disclosure generally relates to a laboratory automated system comprising a sample workflow manager and to a method for processing sample tubes.

In analytical laboratories, in particular clinical laboratories, a multitude of analyses on biological samples are executed in order to determine physiological and biochemical states of patients, which states can be indicative of a disease, nutrition habits, drug effectiveness, organ function and the like.

Biological samples used in those analyses can be any number of different biological fluids such as blood and urine but are not limited thereto. These biological samples are often provided to the laboratories in sample tubes.

Modern clinical laboratories use networks of analytical devices to automatically process a large number of sample tubes per day and in particular to analyze a very large number of biological samples in a given hour. In order to meet this demand, such laboratories are equipped with high-throughput systems comprising a plurality of work cells connected by a conveyor line(s). Within such systems, sample tubes are automatically transported to different work cells via the conveyor line(s).

Sample tubes are normally loaded into the automated clinical systems as they arrive in the laboratory and test orders for each sample are registered. However, the rate at which the samples arrive can vary dramatically throughout the day. Furthermore, each different sample tube may be subjected to various different pre-analytical, analytical and post-analytical processing steps by one or more work cells according to a particular workflow, which depends on the particular type of sample and the specific test order. Sometimes tests need to be repeated and/or the sample tubes need to undergo another series of processing steps.

As the various work cells that are included in a particular automated system can process only a certain maximum number of samples per hour (throughput), and different work cells normally have different throughputs, a sample buffer is typically coupled to each work cell. A plurality of sample tubes are thus temporarily parked in each sample buffer in front of each work cell and sample tubes are processed by the respective work cell when the resources of the work cell become available. Such work cell sample buffers can also be employed to store processed sample tubes in case the samples need to be re-tested. In addition, or alternatively, sample tubes may be kept running on the conveyor line until the resources of a work cell are available and/or until a confirmation is received that a re-test is not required. Often, individual sample tubes have to be transported to different work cells to undergo different processing steps and/or different tests. This causes interdependencies between work cells.

Managing this complex workflow may be very challenging and, as the complexity of the system increases, workflow management becomes less efficient. This means that the full capacity of the system is not used and the throughput of the overall system is lower than the sum of the throughputs of the single work cells. Storing samples in front of each work cell and/or on a conveyor system has the effect of blocking the movement of sample tubes until the blockage can be removed. For example, if a sample tube is stored in a buffer coupled to a work cell and another work cell becomes available within the system to process that sample tube it may be the case that other sample tubes will have to be moved in order to extract the sample tube from the work cell, and if the conveyor is occupied with stored samples, the sample be will have to await a free location in the conveyor in order to be moved. These extra steps lead to increased complexity and increased time needed for a sample tube to be processed. For laboratories handling thousands of samples each day, the difference a small delay for each individual sample makes is substantial when viewed in terms of overall laboratory efficiency.

### SUMMARY

A new laboratory automated system comprising a plurality of work cells coupled to a conveyor and a method for processing sample tubes are disclosed, both of which enable a system to maintain the maximum overall throughput regardless of the number and throughput of the individual work cells and regardless of the frequency at which sample tubes are loaded into the system. This is achieved by a sample buffer module coupled to the conveyor, the sample buffer module being in common to the plurality of work cells, and by a sample workflow manager configured to dispatch sample tubes from the sample buffer module to the work cells via the conveyor with a frequency for each work cell, which is equal to the sample processing throughput of each respective work cell.

One advantage of particular disclosed embodiments is that is that the mechanical complexity of the system is reduced since individual sample buffers coupled to each work cells can be eliminated or reduced in size and complexity, thus resulting also in space and cost savings and reduced risk of mechanical failure and downtimes. An additional advantage of particular embodiments is that the conveyor is occupied only with those sample tubes to which a destination work cell has already been assigned and which are ready to be received by the work cell when they arrive. Furthermore, an additional advantage of particular embodiments is that sample tubes are more readily available to any work cell should a re-test be required. Another advantage of certain embodiments is that it is possible to manage the sample workflow without the need for detailed processing status information from the various work cells, thus simplifying software and electronic interfaces.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates schematically an example of laboratory automated system for processing sample tubes according to an embodiment of the present disclosure.

FIG. 2 illustrates schematically an example of method for processing sample tubes according to an embodiment of the present disclosure.

FIG. 3 illustrates schematically a possible continuation of the method of FIG. 2 according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A new laboratory automated system for processing sample tubes is described. The system comprises a conveyor and a plurality of work cells coupled as modules to the conveyor so that sample tubes can be transported by the conveyor to the work cells, wherein the work cells have respective sample processing throughputs.

A “laboratory automated system” is an instrument for the automated processing of samples for in vitro diagnostics. In general, the system may have different configurations according to the need and/or according to the desired laboratory workflow. Different configurations may be obtained by adding and/or removing and/or differently arranging modules, called “work cells”, along the conveyor. The work cells may have dedicated functions and may be configured to cooperate with any one or more other work cells for carrying out dedicated tasks of a sample processing workflow, which may be a prerequisite before proceeding to another work-cell. Alternatively, work cells may work independently from each other, e.g. each carrying out a separate task, e.g. a different type of analysis on the same sample or different sample. A “work cell” is thus a sample processing module within a larger system wherein “sample processing” means performing a number of pre-analytical and/or analytical and/or post-analytical steps. Processing steps may comprise loading and/or unloading and/or transporting and/or storing sample tubes or racks comprising sample tubes, loading and/or unloading and/or transporting and/or storing reagent containers or cassettes, loading and/or unloading and/or transporting and/or storing and/or washing reagent vessels, e.g. cuvettes, loading and/or unloading and/or transporting and/or storing pipette tips or tip racks, reading and/or writing information bearing codes, e.g. barcodes or RFID tags, washing pipette tips or needles or reaction vessels, e.g. cuvettes, mixing paddles, mixing of samples with other liquid, e.g. reagents, solvents, diluents, buffers, decapping, recapping, pipetting, aliquoting, centrifuging, analyzing, detecting, evaluating results, etc. . . .

In particular, a work cell may be an “analytical work cell” dedicated to the analysis of samples, i.e. qualitative and/or quantitative evaluation of samples for diagnostic purpose. An analytical work cell may comprise units for pipetting, dosing, mixing of samples and/or reagents. The analytical work cell may comprise a reagent holding unit for holding reagents to perform the analysis. Reagents may be arranged for example in the form of containers or cassettes containing individual reagents or group of reagents, placed in appropriate receptacles or positions within a storage compartment or conveyor. It may comprise a consumable feeding unit. In particular, it may comprise one or more liquid processing units, such as a pipetting unit, to deliver samples and/or reagents to the reaction vessels. The pipetting unit may comprise a reusable washable needle, e.g. a steel needle, or disposable pipette tips. The work cell may further comprise one or more mixing units, comprising e.g. a shaker to shake a cuvette or vessel comprising a liquid or a mixing paddle to mix liquids in a cuvette or reagent container. The analytical work cell may comprise a particular detection system and follow a particular workflow, e.g. execute a number of processing steps, which are optimized for certain types of analysis. Examples of such work cells are clinical chemistry analyzers, coagulation chemistry analyzers, immunochemistry analyzers, hematology analyzers, urine analyzers, nucleic acid analyzers, used to detect analytes present in the samples, to detect the result of chemical or biological reactions or to monitor the progress of chemical or biological reactions.

A work cell may be a “pre-analytical work cell” dedicated to prepare samples for analysis. For example a pre-analytical work cell may be configured to open (decap) a sample tube. It may also perform a transformation of the sample such as adding a solvent or material for diluting the sample and/or adding a reagent, in order to facilitate or enable analysis of the sample by an analytical work cell. Examples of operations performed by pre-analytical work cells include, but are not limited to: centrifugation, decapping, transportation, recapping, sorting, and aliquoting.

A work cell may be a “post-analytical work cell” dedicated to process sample tubes after analysis, e.g. for recapping sample tubes and/or for resorting sample tubes and/or for storing and/or disposing sample tubes after being processed by an analytical work cell.

According to certain embodiments the system comprises a plurality of work cells chosen from one or more pre-analytical work cells, one or more analytical work cells, and one or more post-analytical work cells.

According to certain embodiments, the system comprises at least one pre-analytical work cell, at least one analytical work cells and at least one post-analytical work cell.

According to certain embodiments, the system comprises at least two analytical work cells with different sample processing throughputs respectively.

A “conveyor” is a transportation device to which a plurality of work cells may be modularly coupled, e.g. added or removed and they may be itself configurable, e.g. extendable or rearrangeable, in order to adapt to different configurations of the work cells. The term “coupled” means that a connection is established between a work cell and the conveyor through which connection sample tubes may be exchanged, i.e. either enter or exit the work cell and be transported along the conveyor, e.g. to a different work cell. According to certain embodiments, the conveyor is a transportation device adapted to transport sample racks comprising a plurality of sample tubes and/or pucks comprising single sample tubes. According to one embodiment, the conveyor is a transportation pathway comprising one or more transportation lanes or paths, which may be independently controllable, and adapted to transport a plurality of sample tubes, e.g. on racks and/or pucks at the same time. The conveyor may comprise one or more transportation bands, one or more turntables and switches for changing direction and/or path of transportation, etc. . . . According to certain embodiments the conveyor comprises a magnetic or electromagnetic controlling mechanism for transporting sample tubes along different paths. The conveyor may comprise however any type of sample tube moving device, including robotic gripping arms, moving carrier elements, etc. . . .

A “sample tube” is either a sample collection test tube, also called “primary tube”, which is used to receive a sample from a patient and to transport the sample contained therein to an analytical laboratory for diagnostics purposes, or a “secondary tube”, which may be used to receive an aliquot of sample from a primary tube. A primary sample tube is typically made of glass or plastic, has a closed end and an open end that is typically closed by a cap. The cap may be of different materials and may assume different shapes, e.g. different diameters, and colors, typically associated with the type of tube, the type of sample in the tube, the type of conditions the sample is subjected to, and/or the type of process the tube and sample will follow. A secondary tube is typically made of plastic and may have a lower degree of variation of size and type with respect to primary tubes. In particular, secondary tubes may be smaller than primary tubes and be designed to be closed with one type or similar types of cap, e.g. of the screw type.

The term “sample”, refers to a material suspected of containing an analyte of interest. The sample can be derived from any biological source, such as a physiological fluid, including, blood, saliva, ocular lens fluid, cerebral spinal fluid, sweat, urine, milk, ascites fluid, mucous, synovial fluid, peritoneal fluid, amniotic fluid, tissue, cells or the like. The test sample can be pretreated prior to use, such as preparing plasma from blood, diluting viscous fluids, lysis or the like; methods of treatment can involve filtration, distillation, concentration, inactivation of interfering components, and the addition of reagents. A sample may be used directly as obtained from the source or following a pretreatment to modify the character of the sample, e.g. after being diluted with another solution or after having being mixed with reagents e.g. to carry out one or more diagnostic analyses like e.g. clinical chemistry assays, immunoassays, coagulation assays, nucleic acid testing, etc. . . . The term “sample” is therefore not only used for the original sample but also relates to a sample which has already been processed (pipetted, diluted, mixed with reagents, enriched, having been purified, having been centrifuged, etc. . . . ). As used herein, the term “analyte” refers to the compound or composition to be detected or measured.

The system further comprises a sample buffer module coupled to the conveyor, the sample buffer module being in common to the plurality of work cells, wherein “plurality” means at least two work cells and not necessarily all work cells if the system comprises more than two work cells. A “sample buffer module” is a work cell whose primary function is to temporarily receive and store sample tubes before dispatching them to an assigned work cell. The sample buffer module may have other functions like resorting of sample tubes e.g. into different sample tube carriers, e.g. from a transportation rack for a plurality of sample tubes into a single sample tube carrier (puck) or vice versa and/or into a storage rack or vice versa, which may be adapted to receive a different number of sample tubes compared to a transportation rack. The sample buffer module may comprise a decapping and/or recapping unit to remove caps from sample tubes and/or to recap sample tubes. According to certain embodiments the sample buffer module temporarily receives and stores sample tubes, which have already been processed by an analytical work cell, for at least a predetermined time, during which time dispatch to the same or different analytical work cell may be requested for additional processing, e.g. a second analysis (re-testing).

In particular, the sample buffer module may be configured to accommodate a large number of sample tubes, e.g. hundreds of sample tubes in one or more sample tube holders, e.g. receiving trays or racks, which may be movable, e.g. rotatable or translatable on a two-dimensional area or in a three-dimensional space. According to one embodiment, the sample buffer module comprises a sample tube handling device, e.g. a gripper cooperating with a sample tube holder movement mechanism, which enables random access to any of the sample tubes in the sample buffer module.

Different work cells may have different respective sample processing throughputs. The term “sample processing throughput” refers to the number of samples per time unit, that a work cell is able to process, expressed e.g. in number of sample tubes per hour. “Processing” means performing any number of processing steps as above defined, for each sample according to a predefined protocol, which may vary for different samples and/or different types of analysis. Depending on the work cell a plurality of processing steps may be carried out in parallel or in sequence on the same or different samples.

The system further comprises a sample workflow manager. A “sample workflow manager” is a programmable logic controller running a computer-readable program provided with instructions to perform operations in accordance with a process operation plan. The sample workflow manager may comprise a scheduler, for executing a sequence of steps within a predefined cycle time. In particular, the sample workflow manager is configured to dispatch sample tubes from the sample buffer module to the work cells via the conveyor with a frequency for each work cell, which is equal to the sample processing throughput of each respective work cell. This means that the sample buffer module keeps dispatching as many sample tubes per hour to each assigned work cell as each respective work cell can process according to a process operation plan. The frequency at which sample tubes are dispatched to each work cell may thus be fixed for each work cell in common to the sample buffer module according to its respective throughput. As different samples and/or different analyses may require different processing, e.g. a different number of steps, and may require different processing times for the same work cell, an average processing time may be taken into account for defining the frequency of dispatch, which is equal to an average processing throughput of the work cell. In particular, the term “equal” is not intended to mean identical and fixing a frequency of dispatch slightly lower than the sample processing throughput of a work cell may be envisaged if a slight reduction of the overall throughput of the entire system is accepted. For example, dispatching sample tubes with a frequency, which is up to 10-15% lower than the sample processing throughput of a work cell, may be considered substantially equivalent.

According to certain embodiments, the sample workflow manager communicates with the work cells so as to take into account the actual processing status and/or requests of the work cells. According to certain embodiments the system further comprises work cell specific sample buffers coupled to one or more work cells such that a small number (for example, 5 or less, 10 or less, or 15 or less) sample tubes may be temporarily queued before the individual work cells before being processed. The sample workflow manager may in particular be configured to select one of a plurality of possible processing routes in order to avoid dependencies or conflicts between different work cells and maximize the processing throughput of the entire system. The sample workflow manager may for example determine the order of samples to be processed according to the type of analysis, urgency, etc. . . . The sample workflow manager may thus be configured to dispatch a sample tube first to a work cell rather than another work cell if the same sample has to be processed by different work cells in order to avoid queuing, optimize workflow and maximize throughput. The sample workflow manager may also be configured to select different possible transportation routes of the conveyor in order to optimize parallel transportation to different work cells.

According to certain embodiments the system further comprises a loading module coupled to the conveyor for loading sample tubes into the system, wherein the sample workflow manager is configured to dispatch sample tubes from the loading module to the sample buffer module and from the sample buffer module to the work cells. The loading module may comprise a rack tray receiver for receiving rack trays comprising a plurality of sample racks comprising a plurality of sample tubes and/or slots for receiving individual sample racks or individual sample tubes e.g. on single tube carriers. Alternatively, the loading module can load sample tubes in bulk and subsequently place them onto sample tube holders, e.g. directly on the conveyor. The loading unit may have a compartment for STAT samples, i.e. samples with Short Turn Around Time, which have to be processed urgently and therefore have priority over other samples. This information may therefore be taken into account by the sample workflow manager. When determining the sequence with which sample tubes are dispatched.

According to certain embodiments the sample workflow manager is configured to dispatch sample tubes from the loading module directly to an assigned work cell if the frequency at which the work cell is served, at the time new sample tubes are loaded, is lower than its sample processing throughput and is configured to dispatch sample tubes from the loading module to the sample buffer module and from the sample buffer module to the work cell if the frequency at which the work cell is served, at the time new sample tubes are loaded, is equal to or greater than its sample processing throughput. The sample workflow manager may also or in alternative be configured to dispatch sample tubes from the loading module directly to an assigned work cell if the sample tubes are STAT samples tubes.

According to certain embodiments the system comprises an archiving module coupled to the conveyor for storing sample tubes processed by the work cells. In particular, the archiving module may comprise a refrigerated compartment for storing the sample tubes. An example of suitable archiving module is disclosed e.g. in U.S. Pat. No. 8,423,174B2.

According to certain embodiments the system comprises an unloading module coupled to the conveyor for unloading sample tubes from the system wherein the sample workflow manager is configured to dispatch sample tubes to the unloading module from any of the work cells, the sample buffer module or the archiving module. The unloading module may be similar to the loading module and according to certain embodiments the loading module and the unloading module are the same module.

According to certain embodiments the sample workflow manager is configured to dispatch processed sample tubes from the work cells to the common sample buffer module for at least a first predetermined time, during which time additional processing by the same or different work cell may be requested, and to dispatch the processed sample tubes from the sample buffer module to the archiving module or to the unloading module after the first predetermined time.

According to certain embodiments the sample workflow manager is configured to dispatch the sample tubes to the archiving module for a second predetermined time longer than the first predetermined time, during which time additional processing of the sample tubes may be requested, and to dispatch the sample tubes to the unloading unit or to waste after the second predetermined time. The first predetermined time may vary for different samples, it is however typically in the rage of a few minutes to a few hours, whereas the second predetermined time is typically in the range of a few days, also depending on the sample, e.g. from 2 to 10 days.

According to certain embodiments, if additional processing of a sample tube by a work cell is requested, the sample workflow manager is configured to dispatch sample tubes from the archiving module directly to the work cell if the frequency at which the work cell is served is lower than its sample processing throughput and is configured to dispatch sample tubes from the archiving module to the sample buffer module and from the sample buffer module to the work cell if the frequency at which the work cell is served is equal to or greater than its sample processing throughput.

When the sample buffer module comprises a sample tube handling device with random access to any of the sample tubes in the sample buffer module, the workflow manager may be configured to control the sample tube handling device so that sample tubes are dispatched from the sample buffer module in a sequence, which takes into account the throughput of each work cell and optionally the sample processing status of each work cell so that each work cell keeps working at the maximum respective throughput as long as sample tubes assigned to the respective work cell are available in the sample buffer module.

The sample workflow manager may be configured to manage the frequency at which sample tubes enter the sample buffer module and the frequency at which sample tubes leave the sample buffer module such that the sample buffer module keeps working at the maximum throughput and/or at a throughput which is the sum of the sample processing throughputs of the individual work cells in common to the sample buffer module.

A method for processing sample tubes is herein also described. The method comprises assigning sample tubes loaded into a system comprising a conveyor, a plurality of work cells for processing the sample tubes and a sample buffer module modularly coupled to the conveyor, to at least one of the plurality of the work cells, the work cells having respective sample processing throughputs, The methods further comprises the step of dispatching sample tubes loaded into the system to the sample buffer module and from the sample buffer module to the work cells via the conveyor with a frequency for each work cell, which is equal to the sample processing throughput of each respective work cell.

According to certain embodiments, the method comprises dispatching all sample tubes loaded into the system to the sample buffer module.

According to certain other embodiments, the method comprises dispatching sample tubes directly to at least one of the plurality of work cells and bypassing the sample buffer module if the frequency at which the work cell is served is lower than its sample processing throughput and dispatching sample tubes from the loading module to the sample buffer module and from the sample buffer module to the work cell if the frequency at which the work cell is served is equal to or greater than its sample processing throughput.

According to certain embodiments the method comprises dispatching the sample tubes processed by the work cells from the work cells to the sample buffer module at least for a predetermined time.

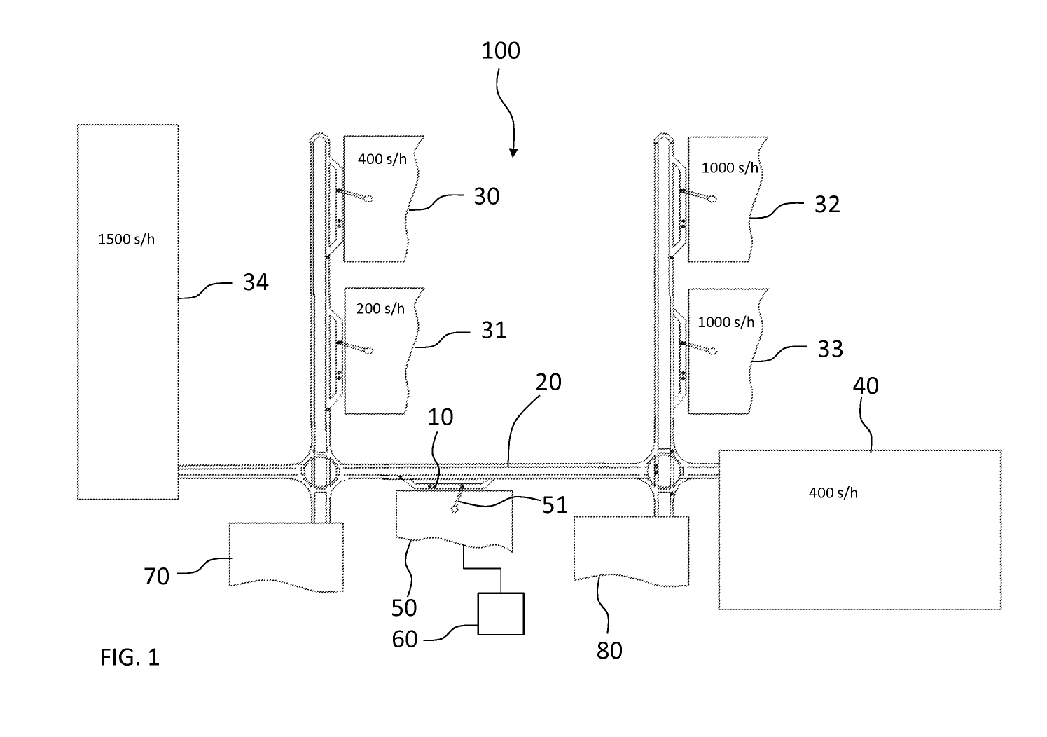

FIG. 1 shows schematically a laboratory automated system 100 for processing sample tubes 10. The system 100 comprises a conveyor 20 and a plurality of work cells 30, 31, 32, 33, 34, 35, 40 coupled as modules to the conveyor 20 so that sample tubes can be transported by the conveyor 20 to the work cells 30, 31, 32, 33, 34, 40. The conveyor 20 is a transportation device adapted to transport sample racks comprising a plurality of sample tubes and/or pucks comprising single sample tubes (not shown in detail). In particular, the conveyor 20 is embodied as a linear transportation pathway comprising a plurality of transportation paths, which are independently controllable, and is adapted to transport a plurality of sample tubes, e.g. on racks and/or pucks, at the same time and in different directions. The work cell 34 is a pre-analytical module comprising a plurality of sub modules each dedicated to a particular pre-analytical sample tube processing step, such as centrifuging, decapping, aliquoting, resorting, etc. . . . The pre-analytical work cell 34 can process in total 1500 s/h (sample tubes/hour). The work cells 30, 31, 32, 33 are analytical work cells each configured for certain types of analysis, such as clinical chemistry, coagulation, immunochemistry, hematology, etc. . . . The work cells 30, 31 have a sample processing throughput of 400 and 200 s/h (sample tubes/hour) respectively. The work cells 32, 33 have each a sample processing throughput of 1000 s/h (sample tubes/hour). The work cell 40 is a post-analytical work cell and in particular an archiving module for storing sample tubes 10 processed by the other work cells 30, 31, 32, 33, 34. The archiving module 40 has a sample processing throughput of 400 s/h (sample tubes/hour).

The system 100 further comprises a sample buffer module 50 coupled to the conveyor 20, the sample buffer module 50 being in common to the plurality of work cells, 30, 31, 32, 33, 34, 40.

The system 100 further comprises a sample workflow manager 60 configured to dispatch sample tubes 10 from the sample buffer module 50 to the work cells 30, 31, 32, 33, 34, 40 via the conveyor 20 with a frequency for each work cell 30, 31, 32, 33, 34, 40, which is equal to the sample processing throughput of each respective work cell 30, 31, 32, 33, 34, 40. Thus the workflow manager 60 is configured to dispatch sample tubes 10 from the sample buffer module 50 to the work cell 30 with a frequency of 200 sample tubes/hour, to the work cell 31 with a frequency of 400 sample tubes/hour, to the work cells 32, 33 with a frequency of 1000 sample tubes/hour each, to the archiving module 40 with a frequency of 400 sample tubes/hour, to the work cell 34 with a frequency of 1500 sample tubes/hour, as long as sample tubes assigned to the respective work cell 30, 31, 32, 33, 34, 40 are available in the sample buffer module 50.

The sample buffer module 50 comprises a sample tube handling device 51 with random access to any of the sample tubes in the sample buffer module 50 and the workflow manager 60 is configured to control the sample tube handling device 51 so that sample tubes 10 are dispatched from the sample buffer module 50 in a sequence, which takes into account the throughput of each work cell 30, 31, 32, 33, 34, 40 and optionally the sample processing status of each work cell 30, 31, 32, 33, 34, 40 so that each work cell keeps working at the maximum respective throughput as long as sample tubes assigned to the respective work cell 30, 31, 32, 33, 34, 40 are available in the sample buffer module 50.

The system 100 further comprises a loading module 70 coupled to the conveyor 20 for loading sample tubes 10 into the system 100 and the sample workflow manager 60 is configured to dispatch sample tubes from the loading module 70 to the sample buffer module 50 and from the sample buffer module 50 to the work cells 30, 31, 32, 33, 34, 40.

The sample workflow manager 60 can be configured to dispatch sample tubes from the loading module 70 directly to an assigned work cell 30, 31, 32, 33, 34, 40 if the frequency at which the work cell 30, 31, 32, 33, 34, 40 is served, at the time new sample tubes 10 are loaded, is lower than its sample processing throughput and is configured to dispatch sample tubes 10 from the loading module 70 to the sample buffer module 50 and from the sample buffer module to the work cell 30, 31, 32, 33, 34, 40 if the frequency at which the work cell 30, 31, 32, 33, 34, 40 is served is equal to or greater than its sample processing throughput. A sample tube 10 may follow a workflow path from work cell to work cell. For example, a sample tube 10 may be assigned first to the pre-analytical work cell 34, then to at least one of the analytical work cells 30, 31, 32, 33, and then to the archiving module 40. Once the sample tube 10 has been dispatched to the first assigned work cell, e.g. the pre-analytical work cell 34, it may proceed to the next assigned work cell, e.g. any of the work cells 30, 31, 32, 33 directly or via the sample buffer module 50. The system 100 further comprises an unloading module 80 coupled to the conveyor 20 for unloading sample tubes 10 from the system 100 wherein the sample workflow manager 60 is configured to dispatch sample tubes 10 to the unloading module 80 from any of the work cells 30, 31, 32, 33, 34, the sample buffer module 50 or the archiving module 40.

The sample workflow manager 60 can be configured to dispatch processed sample tubes 10 from the work cells 30, 31, 32, 33, 34 to the common sample buffer module 50 for at least a first predetermined time, during which time additional processing by the same or different work cell 30, 31, 32, 33, 34 may be requested, and to dispatch the processed sample tubes 10 from the sample buffer module 50 to the archiving module 40 or to the unloading module 80 after the first predetermined time.

The sample workflow manager 60 can be further configured to dispatch the sample tubes 10 to the archiving module 50 for a second predetermined time longer than the first predetermined time, during which time additional processing of the sample tubes 10 may be requested, and to dispatch the sample tubes 10 to the unloading unit 80 or to waste after the second predetermined time.

The sample workflow manager 60 can be configured to dispatch sample tubes 10 from the archiving module 40 directly to a work cell 30, 31, 32, 33, 34, if additional processing of a sample tube 10 by the work cell 30, 31, 32, 33, 34 is requested and if the frequency at which the work cell 30, 31, 32, 33, 34 is served is lower than its sample processing throughput and can be configured to dispatch sample tubes 10 from the archiving module 40 to the sample buffer module 50 and from the sample buffer module 50 to the work cell 30, 31, 32, 33, 34 if the frequency at which the work cell 30, 31, 32, 33, 34 is served is equal to or greater than its sample processing throughput.

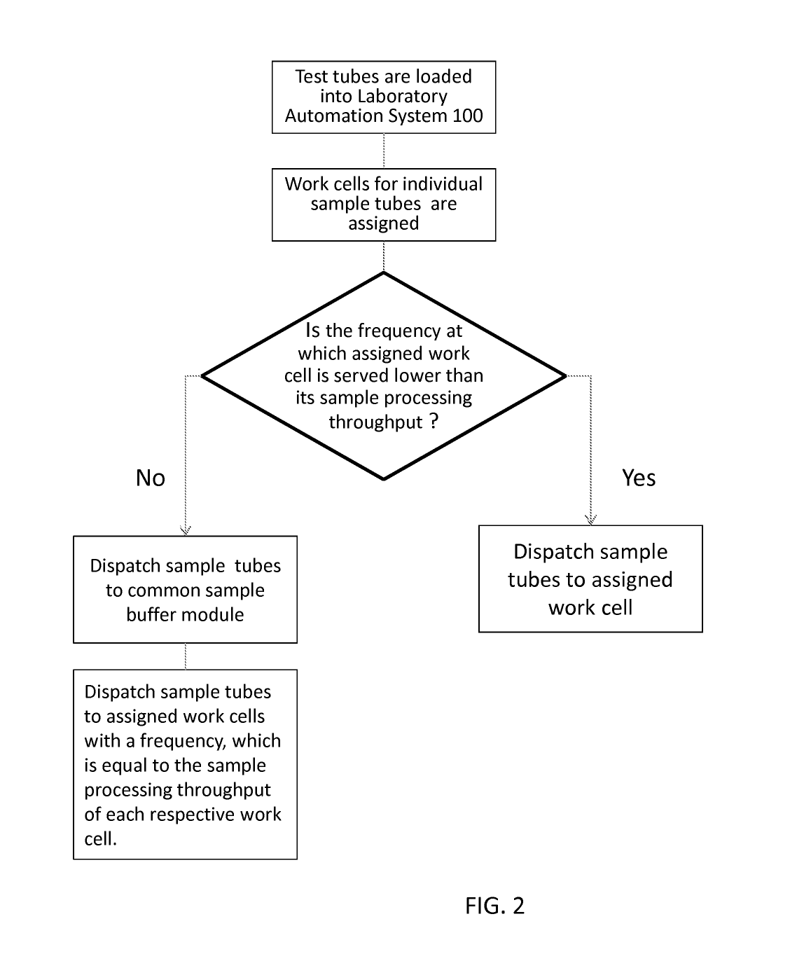

FIG. 2 depicts a possible method for processing sample tubes 10. The method comprises assigning sample tubes 10 loaded into the system 100 to at least one of the plurality of work cells 30, 31, 32, 33, 34, 40. The method further comprises dispatching sample tubes 10 loaded into the system 100 to the sample buffer module 50 and from the sample buffer module 50 to the work cells 30, 31, 32, 33, 34, 40 via the conveyor 20 with a frequency for each work cell 30, 31, 32, 33, 34, 40, which is equal to the sample processing throughput of each respective work cell 30, 31, 32, 33, 34, 40. In particular, the method comprises checking whether the frequency at which an assigned work cell 30, 31, 32, 33, 34, 40 is served is lower than its sample processing throughput. If the frequency at which an assigned work cell 30, 31, 32, 33, 34, 40 is served is lower than its sample processing throughput, the method comprises dispatching the sample tubes directly to the assigned work cell 30, 31, 32, 33, 34, 40. If the frequency at which an assigned work cell 30, 31, 32, 33, 34, 40 is served is equal to or greater than its sample processing throughput, the method comprises dispatching the sample tubes 10 to the sample buffer module 50 and from the sample buffer module 50 to the work cells 30, 31, 32, 33, 34, 40 via the conveyor 20 with a frequency for each work cell 30, 31, 32, 33, 34, 40, which is equal to the sample processing throughput of each respective work cell 30, 31, 32, 33, 34, 40.

The method may be adapted such that all sample tubes 10 loaded into the system 100 are dispatched to the sample buffer module 50 regardless of the frequency at which sample tubes 10 are loaded or at which an assigned work cell 30, 31, 32, 33, 34, 40 is served.

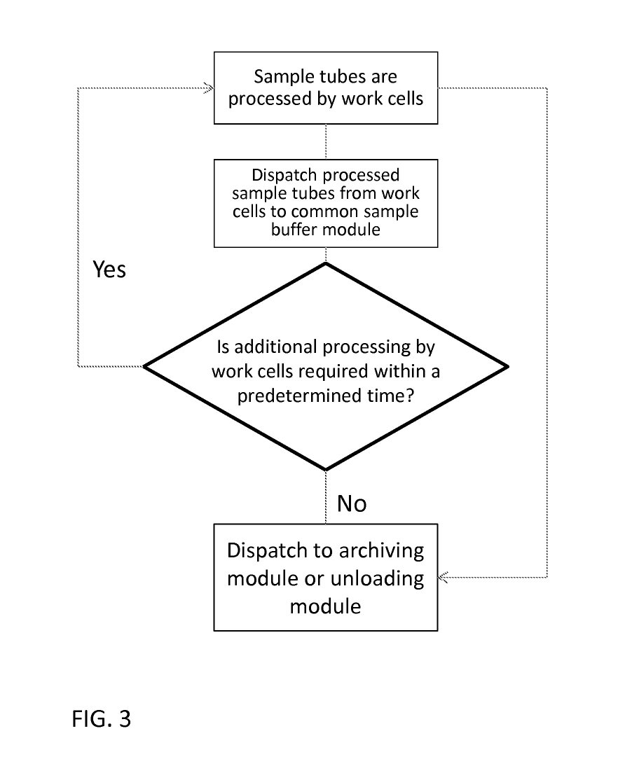

FIG. 3 depicts a method of further processing sample tubes 10 already processed by the work cells 30, 31, 32, 33, 34. The method comprises dispatching the sample tubes 10 processed by the work cells 30, 31, 32, 33, 34from the work cells 30, 31, 32, 33, 34to the sample buffer module 50 at least for a predetermined time. The method further comprises dispatching sample tubes 10 from the sample buffer module 50 to the same or different work cell 30, 31, 32, 33, 34 if additional processing (re-testing) is required within the predetermined time. If no additional processing is required within the predetermined time, the method comprises dispatching the sample tubes 10 to the archiving module 40 for at least a second predetermined time or to the unloading module 80. The method may comprise dispatching the sample tubes 10 directly from a work cell 30, 31, 32, 33, 34, 40 to the archiving module 40 or to the unloading module 80 after additional processing.

Obviously many modifications and variations of the disclosed embodiments are possible in light of the above description. It is therefore to be understood, that within the scope of the appended claims, the invention may be practiced otherwise than as specifically devised in the above examples.

In particular, the number of work cells 30, 31, 32, 33, 34, 40 as well as their respective throughputs is only exemplary. It is also to be understood that dispatching sample tubes 10 to a plurality of work cells means dispatching sample tubes to at least two work cells and not necessarily to all work cells if the system comprises more than two work cells.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. An automated laboratory system for processing sample tubes, the system comprising:
a conveyor and a plurality of work cells coupled as modules to the conveyor so that sample tubes can be transported by the conveyor to the work cells, wherein each work cell has a respective sample processing throughput and wherein at least one work cell is an archiving module;
a sample buffer module coupled to the conveyor, the sample buffer module being in common to the plurality of work cells;
a loading module coupled to the conveyor for loading sample tubes into the system;
an unloading module coupled to the conveyor for unloading sample tubes from the system; and
a sample workflow manager configured to dispatch sample tubes from the sample buffer module to the work cells via the conveyor with a frequency for each work cell that is equal to its respective sample processing throughput, wherein the sample workflow manager is further configured to dispatch already processed sample tubes from the work cells to the common sample buffer module for at least a first predetermined time, during which time additional processing by a same or different work cell can be requested and to dispatch the already processed sample tubes from the sample buffer module to the archiving module or to the unloading module after said first predetermined time.

2. The system according to claim 1, wherein the sample workflow manager is further configured to dispatch sample tubes from the loading module directly to an assigned work cell if the frequency at which said assigned work cell is served, at the time new sample tubes are loaded, is lower than its sample processing throughput and is configured to dispatch sample tubes from the loading module to the sample buffer module and from the sample buffer module to said work cell if the frequency at which said assigned work cell is served, at the time new sample tubes are loaded, is equal to or greater than its sample processing throughput.

3. The system according to claim 1, wherein the sample workflow manager is further configured to dispatch the sample tubes to the archiving module for a second predetermined time that is longer than the first predetermined time, during which time additional processing of the sample tubes can be requested, and to dispatch the sample tubes to the unloading unit or to waste after said second predetermined time.

4. The system according to claim 3, wherein the sample workflow manger is further configured such that if additional processing of sample tubes by a particular work cell is requested, the sample workflow manager dispatches the sample tubes from the archiving module directly to said particular work cell if the frequency at which said particular work cell is served is lower than its sample processing throughput and dispatches sample tubes from the archiving module to the sample buffer module and from the sample buffer module to said particular work cell if the frequency at which said work cell is served is equal to or greater than its sample processing throughput.

5. The system according to claim 1, wherein at least two work cells of the plurality of work cells are analytical modules with different sample processing throughputs.

6. The system claim 1, wherein the conveyor is a transportation device adapted to transport sample racks carrying a plurality of sample tubes and/or pucks carrying single sample tubes.

7. The system according to claim 1, wherein the sample buffer module comprises a sample tube handling device with random access to any of the sample tubes in the sample buffer module and the workflow manager is further configured to control the sample tube handling device so that sample tubes are dispatched from the sample buffer module in a sequence that takes into account the throughput of each particular work cell in the plurality of work cells and/or a sample processing status of each work cell, so that each work cell keeps working at a maximum respective throughput as long as sample tubes assigned to a particular work cell are available in the sample buffer module.

8. A method for processing sample tubes, the method comprising:
assigning sample tubes loaded into a system, the system comprising, a conveyor, a plurality of work cells for processing the sample tubes and a sample buffer module modularly coupled to the conveyor, to at least one of the plurality of the work cells, the work cells having respective sample processing throughputs; and
dispatching sample tubes loaded into the system to the sample buffer module and from the sample buffer module to the work cells via the conveyor with a frequency for each work cell that is equal to the sample processing throughput of each respective work cell.

9. The method according to claim 8, further comprising,
dispatching sample tubes loaded into the system directly to at least one of the plurality of work cells,
bypassing the sample buffer module if the frequency at which said work cell is served is lower than its sample processing throughput, and
dispatching sample tubes to the sample buffer module and from the sample buffer module to said work cell if the frequency at which said work cell is served is equal to or greater than its sample processing throughput.

10. The method according to claim 8, further comprising,
dispatching the sample tubes processed by the work cells from the work cells to the sample buffer module for at least a predetermined time.
